(19) United States
(12) Patent Application Publication
(10) Pub. No.: US 2024/0363020 A1
(43) Pub. Date: Oct. 31, 2024

(54) METHOD AND APPARATUS FOR MANAGING TASKS TO PROMOTE HEALTH AND WELLNESS

(71) Applicant: C. Travis Webb, Costa Mesa, CA (US)

(72) Inventor: C. Travis Webb, Costa Mesa, CA (US)

(21) Appl. No.: 18/765,159

(22) Filed: Jul. 5, 2024

Related U.S. Application Data
(63) Continuation of application No. 17/984,744, filed on Nov. 10, 2022.
(60) Provisional application No. 63/278,048, filed on Nov. 10, 2021.

(51) Int. Cl. G09B 19/00; G09B 5/02

(52) U.S. Cl. CPC G09B 19/003; G09B 5/02

(57) ABSTRACT

Certain aspects relate to methods, apparatuses, and computer readable mediums for an adaptive training program to manage tasks to promote health and wellness. For example, an apparatus for an adaptive training program generally includes an interface configured to receive an input associated with a condition of a user. The apparatus also includes a processing system configured to select a set of tasks from a collection of tasks based on the input associated with the condition of the user; display the set of tasks to the user; and track a completion of the set of tasks by the user. The condition of the user may include at least one of an energy level and an emotional state of the user that is reported by the user. A method for implementing an adaptive training program is also disclosed.

### BACKGROUND

### Field

Aspects of the present disclosure relate generally to systems for creating curated instructional programs, and more particularly, to a method and apparatus for managing tasks to promote health and wellness.

### Background

Current curated instructional/coaching programs, whether it is for physical therapy, wellness, or even tutoring students (e.g., music, academia, etc.), are not as effective if the emotional/energy states of the personal being helped is low. For example, a music student may be tired (e.g., because of not having had a good night's sleep or being stressed from a school exam), this affects their performance and, just as importantly, their progress.

Consequently, it would be desirable to address one or more of the deficiencies described above.

### SUMMARY

The following presents a simplified summary of one or more aspects of the disclosed approach for implementing curated human-created task lists in which a curator may create one or more task lists, then rates tasks for difficulty and schedules a health and wellness regimen based on the end-users or healthcare providers desired outcomes. The end-user then executes those tasks in the pursuit of rehabilitation, skill acquisition, psychological or fitness goal, or any other health and wellness related activity.

This summary is not an extensive overview of all contemplated features of the disclosure and is intended neither to identify key or critical elements of all aspects of the disclosure nor to delineate the scope of any or all aspects of the disclosure. Instead, its sole purpose is to present some concepts of one or more aspects of the disclosure in a simplified form as a prelude to the more detailed description that is presented later herein.

According to various aspects, the subject innovation relates to a method and apparatus for managing tasks to promote health and wellness. In one aspect, the disclosure provides a method for providing an adaptive program for a user to learn a skill, the method including querying the user for an input associated with a condition of the user, selecting a set of tasks from a collection of tasks based on the input associated on the condition of the user, and then presenting the set of tasks to the user. The method further includes tracking a completion of the set of tasks by the user. The method also includes presenting the set of tasks for that day based on inputs from the curator and the cumulative usage history of the user. In general, this might mean that tasks could be pulled from other lists with different degrees of difficulty that fit the parameters set by the curator or user.

Other aspects of the disclosure provide for considering the condition of the user that includes at least one of an energy level or an emotional state of the user. This may include receiving an input from the user, the input including at least one of a positive, neutral, or negative response to the training.

In another aspect, an apparatus for an adaptive training program is also described that includes an interface configured to receive an input associated with a condition of a user. The apparatus further includes a processing system configured to select a set of tasks from a collection of tasks based on the input associated with the condition of the user; display the set of tasks to the user; and track a completion of the set of tasks by the user.

In still yet another aspect, a computer-readable medium for an adaptive training program is also described herein. The computer-readable medium includes code for receiving an input associated with a condition of a user. The computer-readable medium also includes code for selecting a set of tasks from a collection of tasks based on the input associated with the condition of the user; displaying the set of tasks to the user; and tracking a completion of the set of tasks by the user

These and other aspects of the invention will become more fully understood upon a review of the detailed description, which follows.

### BRIEF DESCRIPTION OF THE DRAWINGS

These and other sample aspects of the disclosure will be described in the detailed description that follow, and in the accompanying drawings.

FIG. 1 is a block diagram conceptually illustrating an example of an architecture for implementing a method and apparatus for managing tasks to promote health and wellness.

FIG. 2 is a flow chart of various aspects of the operation of the architecture of FIG. 1.

FIG. 3 is a block diagram illustrating an example of a hardware implementation for an apparatus employing a processing system that may be used in various aspects of the present invention.

In accordance with common practice, some of the drawings may be simplified for clarity. Thus, the drawings may not depict all of the components of a given apparatus (e.g., device) or method. Finally, like reference numerals may be used to denote like features throughout the specification and figures.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Various aspects of the present invention provide for a method and apparatus for managing tasks to promote health and wellness, physical rehabilitation, behavioral modification, skill acquisition, or self-improvement. Each program is based on a collection of task lists in which a curator (e.g., teacher, medical professional, coach, etc.) rates each task for difficulty. Then, drawn from this collection of tasks, an adaptive task list, which may be referred to as a curated program is presented to a user (e.g., a student, patient, client) that follows a customizable set of conditional logic triggers that depend on the energy/emotional state reported by the user for that session, and may include historical performances for the user.

One aspect of the present invention may provide a curator the ability to generate a curated program, which may also be referred to as an adaptive training program, for one or more users using a feedback loop that may be based on emotional or other energy level of each particular user, and that user's unique usage pattern, as described herein. The feedback loop, which may be reported by each user, allows the curator to create and modify routines and to make lessons better in quality. For example, a comprehensive summary of a progress of the user in the adaptive training program may be accessed by a curator for modification and refinement of the curated program. Another aspect of the present invention may allow the curator to manage a larger number of users more effectively with better outcomes than would otherwise be possible using either traditional methods or fully automated protocols.

As used herein, the term “curator” refers to a person responsible for training another person, referred to as a “user”. The curator may also be referred to as, for example purposes but which should not be limiting, a trainer, a teacher, a doctor, a therapist, a tutor, and/or an instructor. The user may also be referred to as, for example purposes but which should not be limiting, a student, a patient, a trainee, and/or a learner. Also as used herein, the term “routine” may include terms such as, for example purposes but which should not be limiting, practices, lessons, and/or sessions that may be created or moderated by the trainer.

Curated (i.e., human input) task list in which the curator rates tasks for difficulty and schedules a health and wellness regimen based on the end-users or healthcare providers desired outcomes. The end-user then executes those tasks in the pursuit of rehabilitation, skill acquisition, psychological or fitness goal, or any other health and wellness related activity.

This task list is then presented to the user following a customizable set of conditional logic triggers that depend on the users reported emotional state that day, as well as the user's historical usage patterns. And the results of the end-user's activity are reported back to the curator for reporting and further modification.

Thus, for example, user chooses “easy” five days in a row. However, the curator has set a general rule that states, “push user when input has been unchanged for #days.” Consequently, when the student completes their fifth task the system says, “Hey, username, feel like pushing yourself today?” Yes/No. “Yes” serves up another moderate task. This is only an example. A user could also be prompted to “take it easy” when they've lodged too many “hard” days.

The system would allow a health care, fitness, or mind-body professional (e.g., physical therapist, psychologist, personal trainer, vocal coach, meditation leader, etc.) to more closely emulate the positive outcomes of one-on-one personal sessions.

### Examples are for Illustration Purposes Only:

1. Teacher (curator) creates three lists and assigns a random number of tasks to each list.
   a. Challenging
   b. Average
   c. Easy
2. Then each task on the list has a set of parameters (parenthesis are for illustration only)
   a. Challenging
      i. Action A (no more than once per week)
      ii. Action B (up to two times per week, never on consecutive days)
      iii. Action C (priority, repeated only if user selects “challenging” three times or more in a week)
   b. Average
      i. Action A (priority, priority up to twice per week, low priority after twice per week)
      ii. Action B (low priority, only selected once three average tasks have been selected)
      iii. Action C (no limitations on repeatability)
   c. Easy
      i. Action A (low priority, unlimited selection)
      ii. Action B (priority, always select if action is available)
      iii. Action C (priority, no more than 2 times per week)
3. User selects how much energy they feel that day. For example, the user may be presented with an application on a mobile device or a computer to provide an input of their energy level.
   a. [symbol] —High Energy
   b. [symbol] —Typical Day
   c. [symbol] —Low Energy
4. User is presented with a task list drawn from the curated lists based on the energy input provided by the user.
   a. [symbol] —High Energy
      i. One Challenging Task
      ii. One Average Tasks
      iii. Two Easy Tasks
   b. [symbol] —Typical Day
      i. One Average Task
      ii. One Easy Task
   c. [symbol] -Low Energy
      One Easy Task
5. Upon completion of all their assigned tasks, user is asked how they're feeling. This user reporting feature is also customizable by the curator and can be tailored to particular use cases. The application may not only inquire about the user's emotional state, it may also be set to ask a series of questions about the user's experience with the exercise. For example, the application may ask questions such as:
   a. How did you feel about today's session?
   b. Does your [body part/muscle group/self-assessment] feel more or less [adjective]?
      i. i.e., Does your hamstring feel more or less limber?
      ii. i.e., Does your voice feel tired?
      iii. i.e., Does your mind feel more or less restless after your session?
6. User's responses and changes are tracked both in the user's calendar or activity log, and also on the curator's dashboard.
   a. The system would alert the curator to any set of parameters the curator sets:
      i. “Fatigued” more than two days in a row
      ii. “Missed session” for three days in a row
   b. The curator may then be prompted to reach out to the user, or modify the user's schedule
   c. Curator could prepare reports to facilitate a change in treatment regimen, or even incorporate the results into a diagnostic assessment.
   d. Gamification parameters can be set at the discretion of the curator and user.

### Scenarios (for Illustration Purposes Only)

1. Physical therapist (curator) begins seeing a patient (user) for a back injury. Upon examination it becomes clear the patient has a number of structural deficiencies including a seriously enervated left gluteus maximus, and a restricted range of motion in both of her ankles.
   a. The patient requires a substantial number of exercises to address her structural deficiencies and the workout regimen indicated would suggest more than a 90 minutes per day with full adoption.
   b. The physical therapist curates a “plan” for the patient (user) that responds to her energy level on any given day and serves up a series of suggested exercises and repetitions based on that response. Exercises are set to limited or open repeats and are excluded when counter indicated.
   c. Based on the patients reporting and prompted self-assessments the physical therapist is able to adjust the patient's routine more frequently than would be possible following in person visits alone.
2. Student (user) wants to learn to sing and accompany themselves on the piano.
   a. The music teacher (curator) assesses the student's skill level in an initial session and then curates a set of tasks based on the student's maturity and interests. The schema might look something like the grid below (for illustration purposes only)

| Difficult | Moderate | Easy |
|---|---|---|
| 1D: Practice Open Chord | 1M: Practice Open Chord | 1E: Listen to your |
| of Your Choice for 10 m | of Your Choice for 5 m | favorite guitar solo and |
| [limit: no more than 2x | [limit: no more than 2x | find a chord chart for it. |
| per week] | per week; do not pair | See what you already |
| | with 1D] | know. [limit: no more |
| | | than 1x per week] |
| 2D: Practice Strumming | 2M: Practice Strumming | 2E: Practice placing your |
| C for 10 m [limit: no more | C for 5 m limit: no more | fingers on the C chord |
| than 2x per week; do not | than 2x per week; do not | until your fingers start to |
| repeat two days in a row] | repeat two days in a row; | hurt. [limit: no more than |
| | do not pair with 2D] | 2x per week; do not |
| | | repeat two days in a row; |
| | | do not pair with 2M] |
| 3D: Practice Strumming | 3M: Practice Strumming | 3E: Practice placing your |
| D for 10 m [limit: no | D for 5 m [limit: no more | fingers on the D chord |
| more than 2x per week; | than 2x per week; do not | until your fingers start to |
| do not repeat two days in | repeat two days in a row; | hurt. [limit: no more than |
| a row] | do not pair with 3D] | 2x per week; do not |
| | | repeat two days in a row; |
| | | do not pair with 3M] |
| 4D: Practice Strumming | 4M: Practice Strumming | 4E: Practice placing your |
| D for 10 m [limit: no | D for 5 m [limit: no more | fingers on the D chord |
| more than 2x per week; | than 2x per week; do not | until your fingers start to |
| do not repeat two days in | repeat two days in a row; | hurt. [limit: no more than |
| a row] | do not pair with 4D] | 2x per week; do not |
| | | repeat two days in a row; |
| | | do not pair with 4M] |
| 5D: Practice strumming | 5M: Tune your guitar and | 5E: Practice strumming |
| to a metronome with all | have fun strumming for | to a metronome with all |
| open chords for 15 m. | 10 m [limit: no more than | open chords for 7 m. |
| [limit: 3x per week; | 1x per week; do not | [limit: 3x per week; |
| require this task 1x per | repeat two days in a row] | require this task 2x per |
| week] | | week; do not pair with |
| | | 6M] |
| | 6M: Practice strumming | 6E: Write down three |
| | to a metronome with all | guitar solos and bring |
| | open chords for 10 m. | them to your next lesson |
| | [limit: 3x per week; | with TEACHER. [limit: 1x |
| | require this task 2x per | per week] |
| | week; do not pair with | |
| | 5D] | |

Note:
A similar grid could be established for, for example, Fitness Coach, Behavior Therapist, or Physical Therapist for client rehab.

b. Student registers their emotional state (i.e., energy level) on any given day and is served a set of tasks based on that.
c. The students' progress is logged, and the music teacher adjusts the practice sessions as necessary, or when a set of parameters have been triggered:
   i. i.e., Teacher is alerted when Student (end-user) has completed a high energy task five days in a row.
   ii. i.e., Teacher is alerted when Student has started but left unfinished all of their high energy tasks.
3. A patient (user) begins seeing a therapist (curator) because he is dealing with an obsessive-compulsive disorder. They have a compulsion to wash their hands anytime they touch a metal surface. The patient not only washes his hands hundreds of times per day, but he also spends a significant amount of time debating with himself about whether a particular surface was or was not metal. After an initial assessment the therapist comes up with a cognitive behavior therapy (CBT) regimen tailored to the patient's emotional energy on any given day. In this scenario, in addition to the possibilities detailed above in other health and wellness scenarios, the patient's task completions would be gamified so that they can clearly track their positive progress.

It should be noted that a cumulative history of the user may be considered when the curator is creating a regimen.

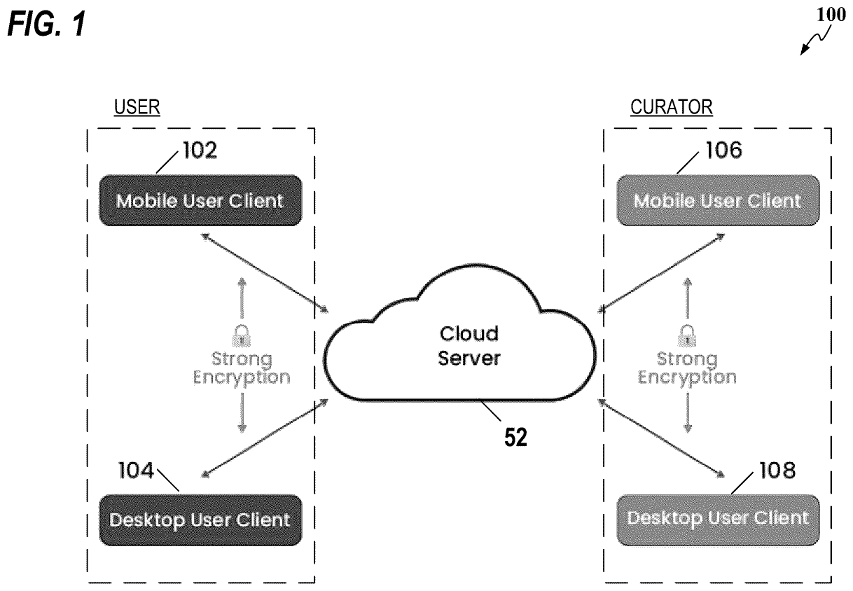

FIG. 1 illustrates a cloud server architecture 100 where one or more users may communicate with a cloud server 52 using a mobile user client 102. The mobile user client 102 may be implemented as an “app” (software application) on a smartphone. The user may also use a desktop user client 104 to access the cloud server 52. The desktop user client 104 may be implemented using software running on a desktop or laptop device. A curator may use a mobile user client 106 or a desktop user client 108 to interact with the cloud server 52 to perform various task management functions. For example, to create the curated lists as described above, assign tasks either automatically or manually adjust the list of tasks to create an assigned set of tasks. The mobile user client 106 and the desktop user client 108, may be implemented similarly to the mobile user client 102 and the desktop user client 104, respectively. Communications between the mobile user client 102, the desktop user client 104, the mobile user client 106, and the desktop user client 108, as well as between any of those clients and the cloud server 52 may be secured by strong encryption protocols.

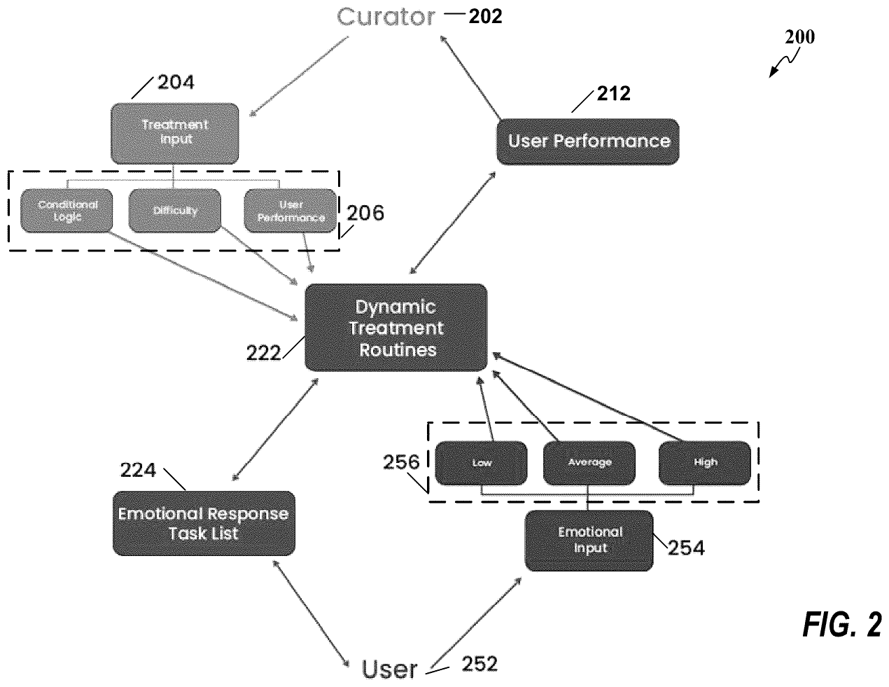

FIG. 2 illustrates an overview of a training process 200 through which a curator 202 and a user 252 may interact through a dynamic treatment procedures module 222. The curator 202 may use an interface on the mobile user client 106 or the desktop user client 108 to interact with various parts of the training process 200. Associated with the curator 202 is a treatment input 204 that includes possible modifications/specifications 206 including conditional logic, difficulty, and user performance. Thus, the curator 202 may create training programs using the treatment input 204 that is based on the possible modifications/specifications 206. The created treatment routines are stored in the dynamic treatment routines 222. The dynamic treatment routines as well as the dynamic treatment module 222 may be stored on the cloud server 52.

The user may use the mobile user client 102 or the desktop user client 104 to interact with various parts of the training process 200. As an example, the user 252 may interact with an emotional input 254 on an interface of the mobile user client 102 or desktop user client 104. The emotional input 254 may include various possible emotional modifications/specifications 256, including low, average, and high emotional states. Instead of, or in additional to, emotional states, energy levels may be used as part of the modifications/specifications. The emotional input 254 may then be provided to the cloud server 52, which may then use the emotional input 254 to generate assigned tasks based on the curator's previously assigned rules or even manually be created/modified by the curator in real-time, as described in various parts of the description.

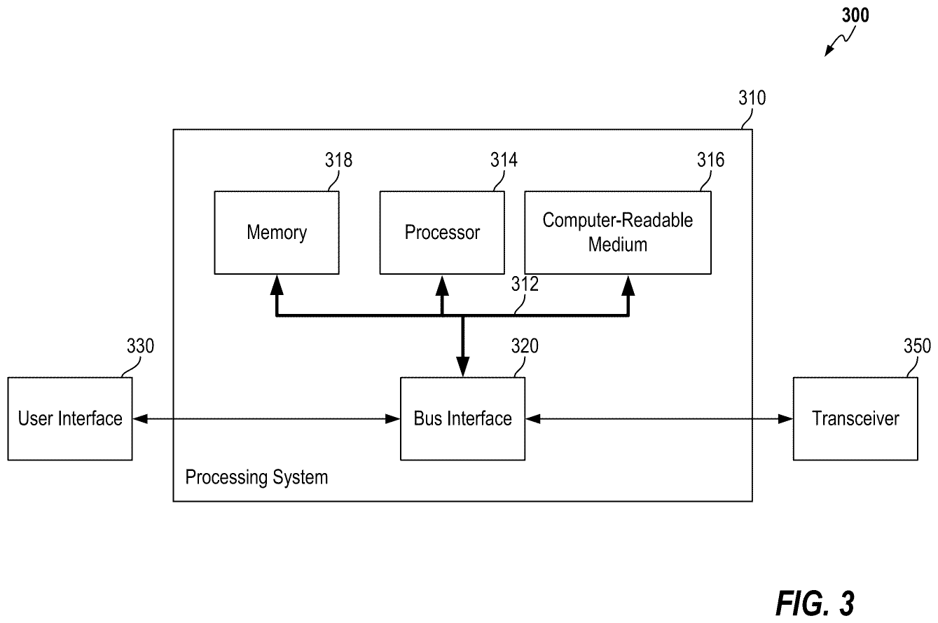

FIG. 3 is a conceptual diagram illustrating an example of a hardware implementation for an apparatus 300 employing a processing system 310 that may be utilized in various aspects of the disclosed approach for the method and apparatus for managing tasks to promote health and wellness. Thus, in accordance with various aspects of the disclosure, an element, or any portion of an element, or any combination of elements in the apparatus 300 that may be used to implement any device, including a computing device (computer, laptop, smartphone, etc.), that can provide the functionalities of the mobile user client 102, the desktop user client 104, the mobile user client 106, and the desktop user client 108, as well as the cloud server 52, as described herein.

For example, the processing system 310 includes one or more processors illustrated as a processor 314. Examples of processors 314 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. Processors such as the processor 314 typically require a clock signal that needs to be distributed throughout various portions of a die configured to implement the processor 314. In accordance with various aspects of the disclosed approach, the clock signal may be distributed externally to the die in a package using at least one interconnect external to the die. The external routing may reduce clock skew and phase offsets of the clock signal that is being distributed in the processor 314 as well as increase available space in the interior portion of the die. In addition to the processor 314 of the processing system 310, it should be noted that any integrated circuit in the apparatus 300 may utilize the external routing techniques in an advantageous manner.

The processing system 310 may be implemented as having a bus architecture, represented generally by a bus 312. The bus 312 may include any number of interconnecting buses and bridges depending on the specific application of the processing system 310 and overall design constraints. The bus 312 links together various circuits including one or more processors (represented generally by the processor 314), a memory 318, and computer-readable media (represented generally by a computer-readable medium 316). The bus 312 may also link various other circuits such as timing sources, peripherals, voltage regulators, and power management circuits, which are well known in the art, and therefore, will not be described any further. A bus interface 320 provides an interface between the bus 312 and a transceiver 350. The transceiver 350 provides a means for communicating with various other apparatus over a transmission medium. For example, to implement a mobile device such as a smartphone, the transceiver 350 may be a wireless transceiver suitable for communicating with a wireless network, whether that wireless network includes a cellular network (e.g., 2G, 3G, 4G, and/or 5G) or a wireless local area network (WLAN) (e.g., Wi-Fi). As another example, for a desktop computer, the transceiver 350 may support communications over a wired network (e.g., Ethernet). In yet another example, for a laptop computer, the transceiver 350 may support communication over both types of networks (wireless and/or wired networks). In addition, whether it is a smartphone, desktop computer, or a laptop computer, the transceiver 350 can be one or more transceivers that supports various types of networks.

Depending upon the nature of the apparatus, a user interface 330 (e.g., keypad/keyboard, display, speaker, microphone, joystick, mouse, or trackpad) may also be provided. The user interface 330 allows a person such as a curator or a student to interact with the software application. For example, the curator may create and input the various lists described above using a combination of keyboard and mouse inputs on the mobile user client 106 or the desktop user client 108 to submit to the cloud server 52. The curator can also preform task assignments using the user interface 330. As another example, the student may use the user interface 330 as implemented on the mobile user client 106 or the desktop user client 108 to provide emotional/energy level input and receive task assignments, as well as provide feedback after completing one or more assigned tasks.

The processor 314 is responsible for managing the bus 312 and general processing, including execution of software that may be stored on the computer-readable medium 316 or the memory 318. The software, when executed by the processor 314, causes the processing system 310 to perform the various functions described herein for any particular apparatus. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The computer-readable medium 316 or the memory 318 may also be used for storing data that is manipulated by the processor 314 when executing software. The computer-readable medium 316 may be a non-transitory computer-readable medium such as a computer-readable storage medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. Although illustrated as residing in the processing system 310, the computer-readable medium 316 may reside externally to the processing system 310, or distributed across multiple entities including the processing system 310. The computer-readable medium 316 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

Those of skill would further appreciate that any of the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. A “set” of elements may refer to any number of those elements, including zero elements. A set with zero elements may also be referred to as a null or empty set. Moreover, a “subset” of a set of elements may also refer to any number of those elements, including zero. In general, unless otherwise noted, the subset will contain a fewer number of elements (including zero elements) than the set from which those elements belong. Further, as applied to information or data, a subset of information or a subset of data may refer to no information or no data, respectively. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

What is claimed is:

1. An apparatus for an adaptive training program comprising:
an interface configured to receive an input associated with a condition of a user; and,
a processing system configured to:
select a set of tasks from a collection of tasks based on the input associated with the condition of the user;
display the set of tasks to the user; and
track a completion of the set of tasks by the user.

2. The apparatus of claim 1, wherein the condition of the user comprises at least one of an energy level and an emotional state of the user.

3. The apparatus of claim 2, wherein the input associated with the condition of the user comprises a received response from the user to a query of the at least one of the energy level and the emotional state of the user.

4. The apparatus of claim 1, wherein the processing system is further configured to show the set of tasks on a display of a computing client of the user.

5. The apparatus of claim 1, wherein the processing system is further configured to track the completion of the set of tasks by the user by receiving a second input from the user, the second input comprising at least one of a positive, neutral, and negative response by the user to the set of tasks after the completion of the set of tasks by the user.

6. The apparatus of claim 1, wherein the processing system is further configured to generate a summary of a progress of the user in the adaptive training program to a curator for modification and refinement of the set of tasks.

7. The apparatus of claim 1, wherein each task in the collection of tasks is associated with a difficulty level.

8. A method for implementing an adaptive training program for managing tasks to promote wellness, the method comprising:
receiving an input associated with a condition of a user;
selecting a set of tasks from a collection of tasks based on the input associated with the condition of the user;
displaying the set of tasks to the user; and
tracking a completion of the set of tasks by the user.

9. The method of claim 8, wherein the condition of the user comprises at least one of an energy level and an emotional state of the user.

10. The method of claim 9, wherein the input associated with the condition of the user comprises a received response from the user to a query of the at least one of the energy level and the emotional state of the user.

11. The method of claim 8, wherein the displaying the set of tasks to the user comprises showing the set of tasks on a display of a computing client of the user.

12. The method of claim 8, wherein the tracking the completion of the set of tasks by the user comprises receiving a second input from the user, the second input comprising at least one of a positive, neutral, and negative response by the user to the set of tasks after the completion of the set of tasks by the user.

13. The method of claim 8, further comprising generating a summary of a progress of the user in the adaptive training program to a curator for modification and refinement of the set of tasks.

14. The method of claim 8, wherein each task in the collection of tasks is associated with a difficulty level.

15. A computer-readable medium comprising code for:
receiving an input associated with a condition of a user;
selecting a set of tasks from a collection of tasks based on the input associated with the condition of the user;
displaying the set of tasks to the user; and
tracking a completion of the set of tasks by the user.

16. The computer-readable medium of claim 15, wherein the condition of the user comprises at least one of an energy level and an emotional state of the user.

17. The computer-readable medium of claim 16, wherein the input associated with the condition of the user comprises a received response from the user to a query of the at least one of the energy level and the emotional state of the user.

18. The computer-readable medium of claim 15, wherein the code for displaying the set of tasks to the user comprises code for showing the set of tasks on a display of a computing client of the user.

19. The computer-readable medium of claim 15, wherein the code for tracking the completion of the set of tasks by the user comprises code for receiving a second input from the user, the second input comprising at least one of a positive, neutral, and negative response by the user to the set of tasks after the completion of the set of tasks by the user.

20. The computer-readable medium of claim 15, further comprising code for generating a summary of a progress of the user in the adaptive training program to a curator for modification and refinement of the set of tasks.

21. The computer-readable medium of claim 15, wherein each task in the collection of tasks is associated with a difficulty level.
